(19) United States
(12) Patent Application Publication
(10) Pub. No.: US 2007/0120021 A1
(43) Pub. Date: May 31, 2007

(54) Hanging clamp for different size rods

(76) Inventors: Yu-Shen Lin, Taichung City (TW); Ling-Xian Wang, Taichung City (TW)

Correspondence Address: PRO-TECHTOR INTERNATIONAL SERVICES, 20775 NORADA CT., SARATOGA, CA, 95070, US

(21) Appl. No.: 11/271,137

(22) Filed: Nov. 11, 2005

(51) Int. Cl. F16L 3/00

(52) U.S. Cl. 248/49

(57) ABSTRACT

The present invention relates to a hanging clamp for different size rods, which comprises a L-shaped base having a body, a rotatory piece capable of rotating at a predetermined angle, as well as a clamping member also capable of rotating at a predetermined angle; wherein a retaining portion projects out of one end of body, the rotatory piece is pivoted at a proper position of body by means of a first pivotal axis, while the clamping member is pivoted at one end of rotatory piece by using a second pivotal axis; furthermore, the clamping member in response to the retaining portion is provided with an arc-shaped clamping surface having a concentric circle, whereby enabling the rotatory piece pivotally rotate the clamping member to clamp different size rods, by using the changeable distance between the clamping surface and the retaining portion; prefectably, the clamping member can also pivotally rotate to increase or decrease said changeable distance between the clamping surface and the retaining portion, so as to expand the clamping size range of hanging clamp for different size rods by using the changeable distance of double pivotal axis.

### BACKGROUND OF THE INVENTION

1. Field of the Invention

The present invention relates to a hanging clamp for different size rods which can expand the clamping size range of the hanging clamp for different size rods by using the changeable distance of double pivotal axis.

2. Description of the Prior Arts

Conventionally, small-size rods, such as hand tools, are easy to be put away by the users due to their specific storage holders designed; however, large-size rods, such as cleaning tools, garden tools, construction tools and the like, are not easy to be put away because of their large sizes. To improve this problem a hanging clamp for putting away large-size rods is disclosed in the Taiwan Serial No. 85204972 of FIGS. 1 and 2 in which, a hanging clamp for different size rods comprises a body 10 having a predetermined length and a predetermined width, an axial portion 11 disposed at one end of body 10, a retaining portion 12 arranged in response to said axial portion 11, wherein the retaining portion 12 is defined with a retaining wall opposite to the axial portion 11. In addition, a clamping member 20 capable of rotating at a predetermined angle is pivoted at the axial portion 11, an arc-shaped clamping surface 21 corresponding to the retaining wall 121 is projectedly formed on the clamping member 20, wherein the distance between the clamping surface 21 and the axial portion 11 extends gradually. After the hanging clamp are assembled by using a plurality of slide members 13 respectively at each side of body 10, the hanging clamp assembly can be located in a base 22 having a plurality of recesses 23, further, the base 22 can locate a plurality of hanging clamp assemblies for putting away a plurality of different size rods. As shown in FIG. 3, because the distance between the clamping surface 21 and the axial portion 11 extends gradually, when the clamping member 20 rotates around the axial portion 11, the distance between the clamping surface 21 and the retaining wall 121 will be changeable in such a manner that the clamping member 20 can clamp different size rods. For example, while the clamping member 20 rotates around the axial portion 11 to extend the distance between the clamping surface 21 and the retaining wall 11 up to the maximum, a first clamping point 211 will therefore occur, the distance length A from the first clamping point 211 to the retaining wall 121 can be used as the maximum clamping range of hanging clamp for different size rods. In other words, if the diameter of a rod is more than the distance length A, the rod can not be clamped by the hanging clamp. In contrast, as shown in FIG. 4, while the clamping member 20 rotates around the axial portion 11 to shorten the distance between the clamping surface 21 and the retaining wall 121 down to the minimum, a second clamping point 212 will therefore occur, the distance length B from the second clamping point 212 to the retaining wall 121 can be used as the minimum clamping range of hanging clamp for different size rods. In other words, if the diameter of a rod is less than the distance length B, the rod can not be clamped by the hanging clamp. However, this Taiwan Patent Application still has the following disadvantages:

1. As shown in FIGS. 3 and 4, if the diameter of a rod is between the distance length A and B, the rod will be efficiently clamped by the hanging clamp, while if the diameter of a rod is more than the distance length A or less than the distance length B, the rod will not be clamped by the hanging clamp. Accordingly, the clamping size range of hanging clamp will be limited.

2. Further, as shown in FIGS. 1 and 2, if the user intends to clamp a plurality of rods, he needs to combine a plurality of hanging clamps together by using a plurality of slide members 13 respectively at each side of body 10 and a plurality of recesses 23 formed on the base 22. Hence, the manufacturing cost of respective hanging clamps will enhance in view of an additional base 22 produced.

The present invention has arisen to mitigate and/or obviate the afore-described disadvantages.

### SUMMARY OF THE INVENTION

The primary objective of the present invention is to provide a hanging clamp for different size rods, which comprises a rotatory piece capable of rotating at a predetermined angle pivoted at a proper position of body by using a first pivotal axis, a clamping member also capable of rotating at a predetermined angle pivoted at one end of rotatory piece by using a second pivotal axis in such a manner that while the rotatory piece rotates around the first pivotal axis, the clamping member will be turned to clamp a rod, wherein the clamping member can clamp different size rods by using the changeable distance between the clamping member and a base, also, said changeable distance can be adjusted again by using the rotation of clamping member around the second pivotal axis. As a result, the clamping size range of hanging clamp for different size rods can be expanded by using the changeable distance of double pivotal axis.

The secondary objective of the present invention is to provide a hanging clamp for different size rods, which comprises a retaining recess formed at one end of the body of base, a retaining projection arranged at another end of body in such a manner that a plurality of hanging clamps can be assembled together to clamp a plurality of rods without manufacturing additional coupling elements. Hence, the manufacturing cost of the respective hanging clamps will be diminished.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is an exploded view of the hanging clamp of the Taiwan Serial No. 85204972;

FIG. 2 is an assembly view of the hanging clamp of the Taiwan Serial No. 85204972;

FIG. 3 shows a perspective view of the maximum clamping range of the hanging clamp of the Taiwan Serial No. 85204972;

FIG. 4 shows a perspective view of the minimum clamping range of the hanging clamp of the Taiwan Serial No. 85204972;

FIG. 5 is an exploded view of a hanging clamp for different size rods in accordance with the present invention;

FIG. 6 is an assembly view of the hanging clamp for different size rods in accordance with the present invention;

FIG. 7 is a cross-sectional assembly view of the hanging clamp for different size rods in accordance with the present invention;

FIG. 8 is an operational view of the hanging clamp for different size rods in accordance with the present invention;

FIG. 9 is another operational view of the hanging clamp for different size rods in accordance with the present invention;

FIG. 10 is another operational view of the hanging clamp for different size rods in accordance with the present invention;

FIG. 11 shows a perspective view of the maximum clamping range of the hanging clamp for different size rods in accordance with the present invention;

FIG. 12 shows another perspective view of the maximum clamping range of the hanging clamp for different size rods in accordance with the present invention;

FIG. 13 shows a perspective view of the minimum clamping range of the hanging clamp for different size rods in accordance with the present invention;

FIG. 14 shows another perspective view of the minimum clamping range of the hanging clamp for different size rods in accordance with the present invention;

FIG. 15 shows an assembly view of a plurality of hanging clamps for different size rods in accordance with the present invention.

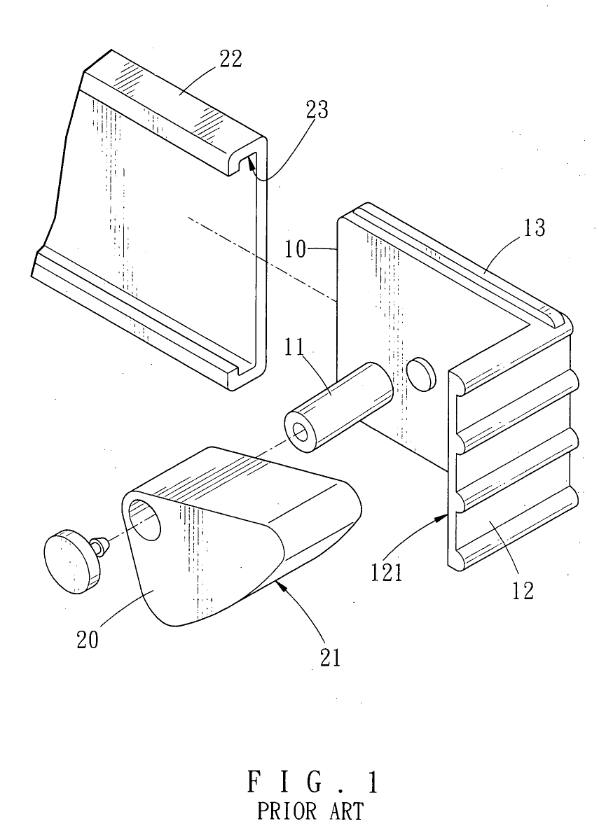

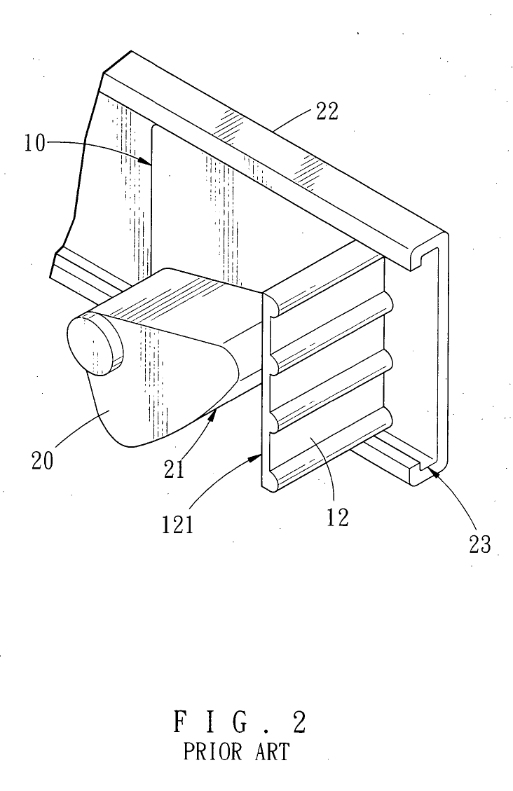

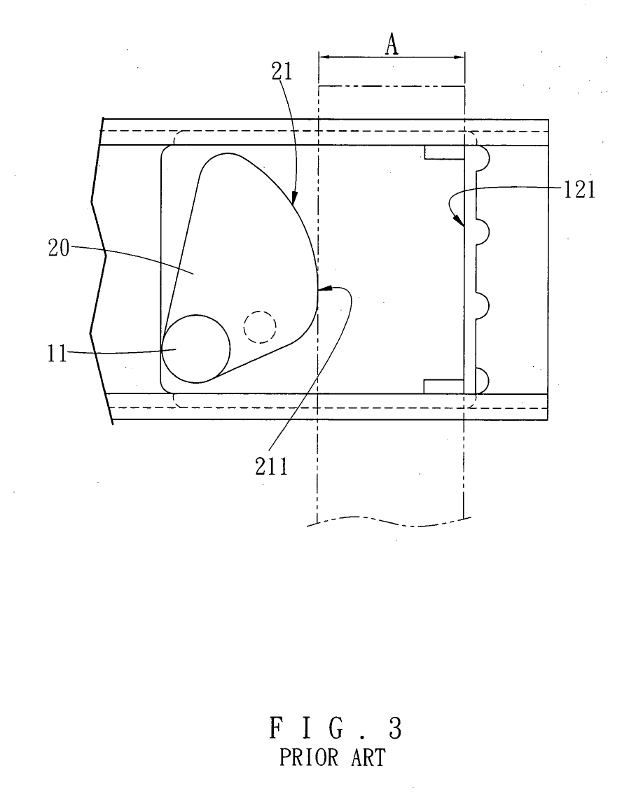

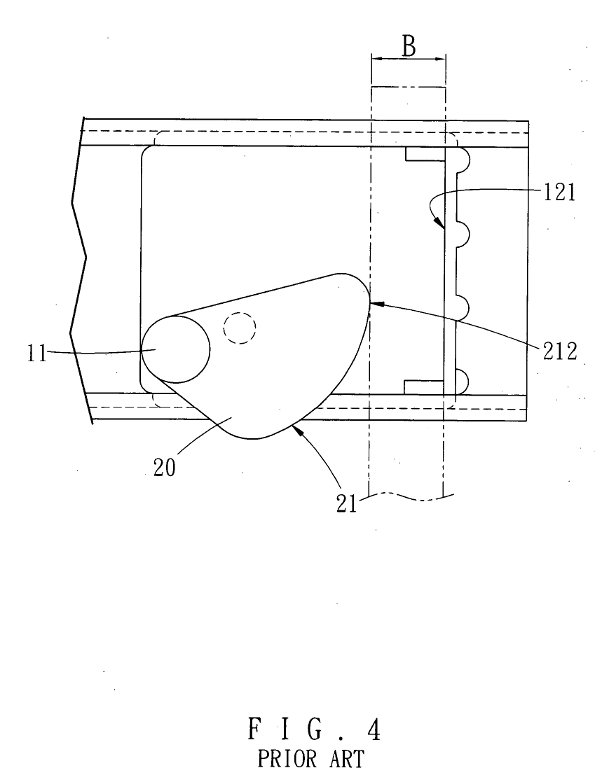

### DETAILED DESCRIPTION OF THE PREFERRED EMBODIMENT

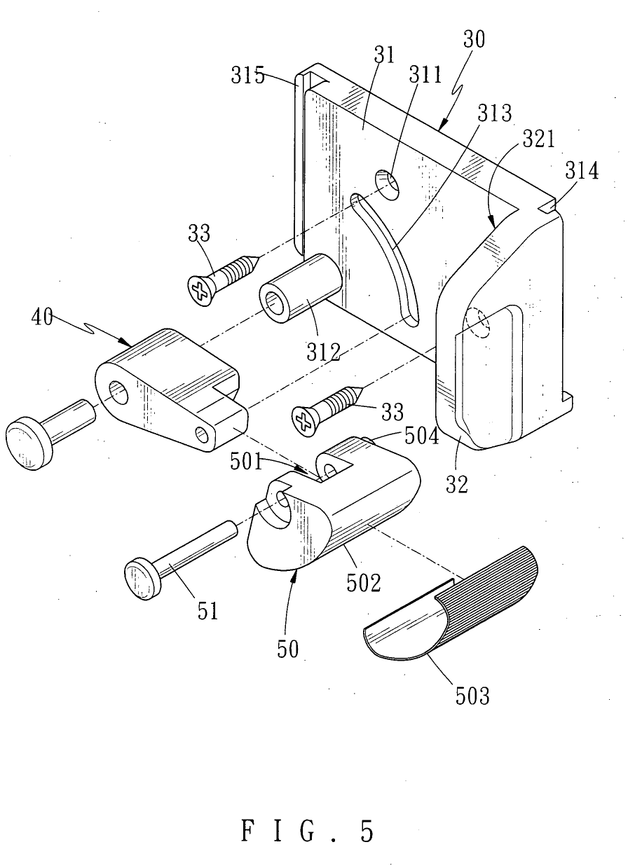

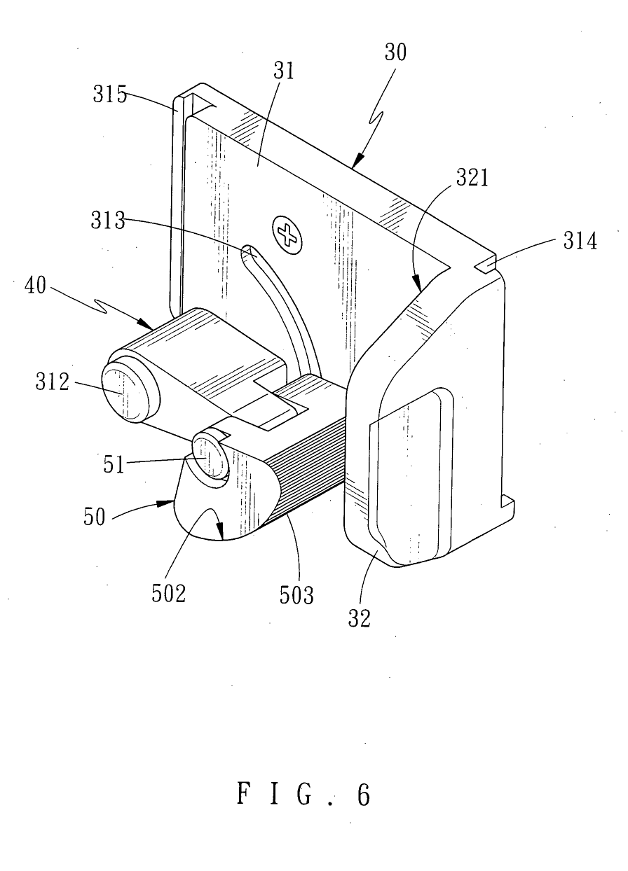

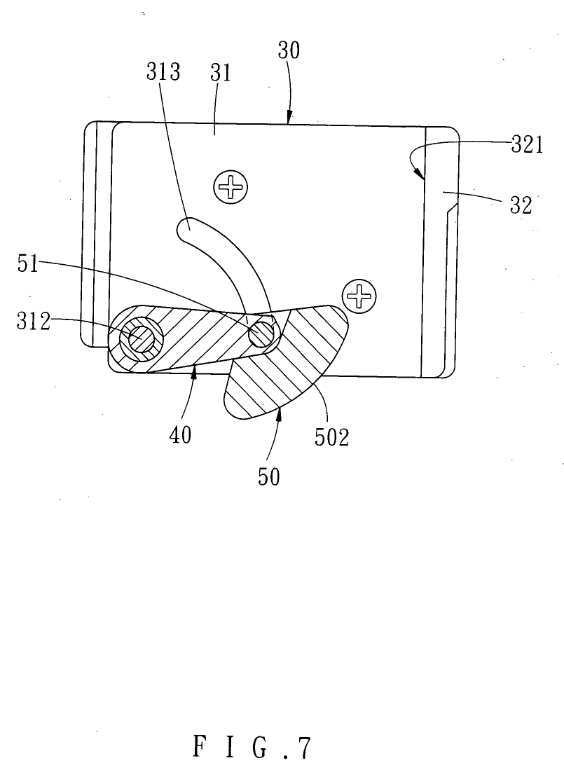

Referring to FIGS. 5-7 a hanging clamp for different size rods in accordance with the present invention is shown and comprises a L-shaped base 30, a rotatory piece 40 as well as a clamping member 50, wherein a body 31 is formed on the base 30, an outwardly projected retaining portion 32 is arranged at one end of body 31, a plurality of through holes 311 for fixing the body 31 to the wall by means of a plurality of bolts 33 are respectively defined on said body 31. Moreover, a first pivotal axis 312 is mounted at a proper position of body 31, an arc-shaped slot 313 having a predetermined angle is formed on the body 31 by using said first pivotal axis 312 as its center, at one end of body 31 is provided with a retaining recess 314, while at another end of body 31 is defined with a retaining projection 315, at the retaining portion 32 in response to the first pivotal axis 312 is arranged a retaining wall 321. One end of the rotatory piece 40 for rotating around the first pivotal axis 312 is pivoted at aforesaid first pivotal axis 312 of body 31; a fitting slot 501 for coupling to another end of rotatory piece 40 is formed at one end of clamping member 50, by using the second pivotal axis 51, the clamping member 50 can pivotally coupled to the rotatory piece 40, so as to the clamping member 50 can rotate around the first pivotal axis 312 by using the rotatory piece 40 and can also rotate around the second pivotal axis 51 in such a manner that the rotation of double pivotal axis will form. At one end of clamping member 50 in response to the retaining wall 321 is formed an arc-shaped clamping surface 502 having a concentric circle, and the center of circle of said clamping surface 502 is not at the first pivotal axis 312, an elastic pad 503 having a plurality of soft and anti-slip strips thereon is affixed to the clamping surface 502, so as to enhance the clamping strength of clamping surface 502. On the other hand, at the bottom of clamping member 50 in response to an arc-shaped slot 313 having a predetermined angle is defined with a pivotal projection 504 for being located and moving in the slot 313. By using the predetermined angle of slot 313, the rotation of rotatory piece 40 at the predetermined angle can be confined. As to the clamping member 50 rotates around the second pivotal axis 51, when it rotates at the top position, one wall of a fitting slot 501 will abut against the top side of rotatory piece 40, so the clamping member 50 will be stopped rotating upwardly, while said clamping member 50 rotates at the bottom position, another wall of fitting slot 501 will abut against the bottom side of rotatory piece 40, so the clamping member 50 will be stopped rotating downwardly in such a manner that the rotatory piece 40 can rotate around the first pivotal axis 312 at a predetermined angle, and the clamping member 50 can rotate around the second pivotal axis 51 at a predetermined angle.

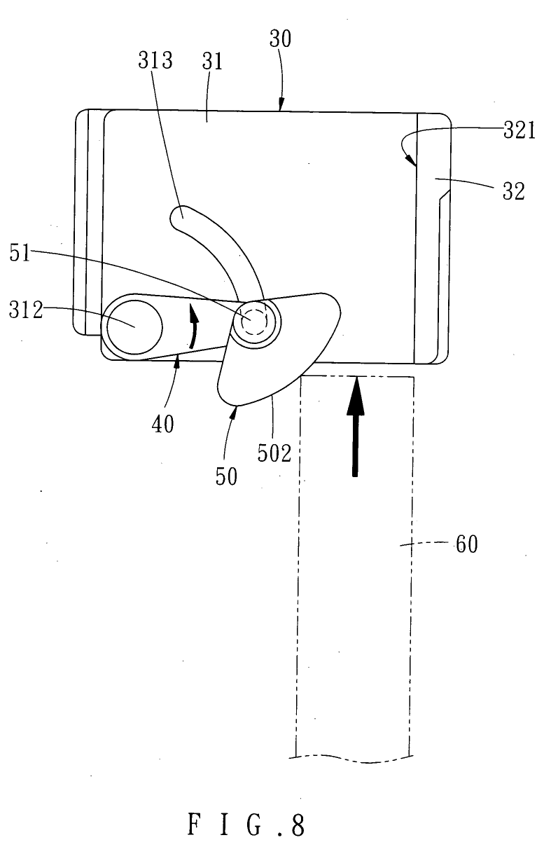

Referring to FIG. 8, a hanging clamp for different size rods in accordance with the present invention is vertically fixed to the wall. Because of the gravity downward, when the rotatory piece 40 and the clamping member 50 don't clamp a rod, they both rotate downward to the bottom position. When the user intends to clamp a rod 60, he will push the rod 60 upward to the clamping surface 502 of clamping member 50, so the rotatory piece 40 and the clamping member 50 will rotate upwardly.

Referring to FIG. 9, because the center of circle of the clamping surface 502 is not at the first pivotal axis 312, when the rotatory piece 40 as well as the clamping member 50 rotate upwardly, the distance between the clamping surface 502 of clamping member 50 and the retaining wall 312 of base 30 will increase gradually, so as to the rod 60 can pass through and then be positioned between the clamping surface 502 and the retaining wall 321.

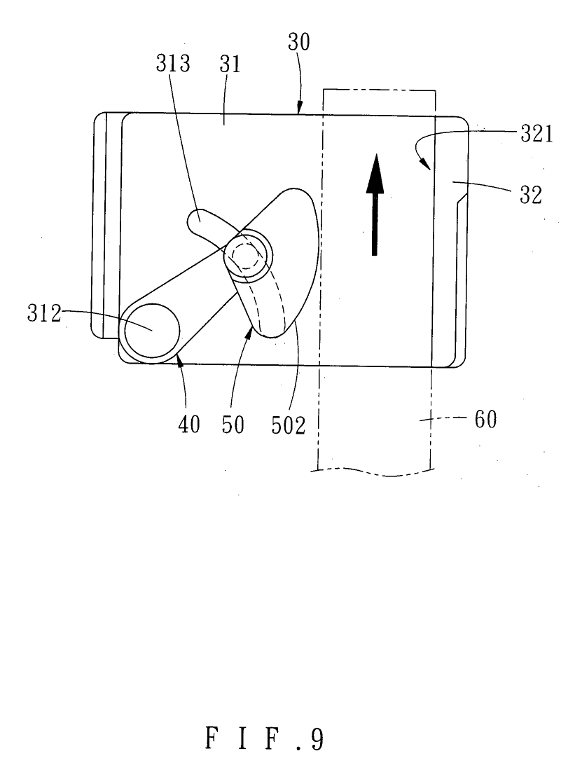

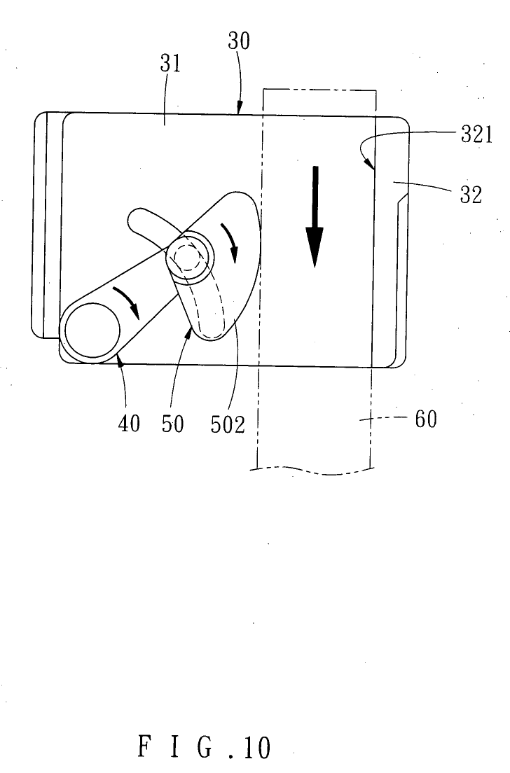

Referring to FIG. 10, when the user releases the rod 60 with hands in view of the gravity downward, the gravities of rod 60, rotatory piece 40 and clamping member 50 will pull the rotatory piece 40 and the clamping member 50 to rotate downward, whereby the distance between the clamping surface 502 and the retaining wall 321 will decrease gradually, so as to the rod 60 can be clamped securely. When the gravity increases, the clamping strength of clamping surface 502 will accordingly enhance, hence, the rod 60 can be securely retained on the hanging clamp.

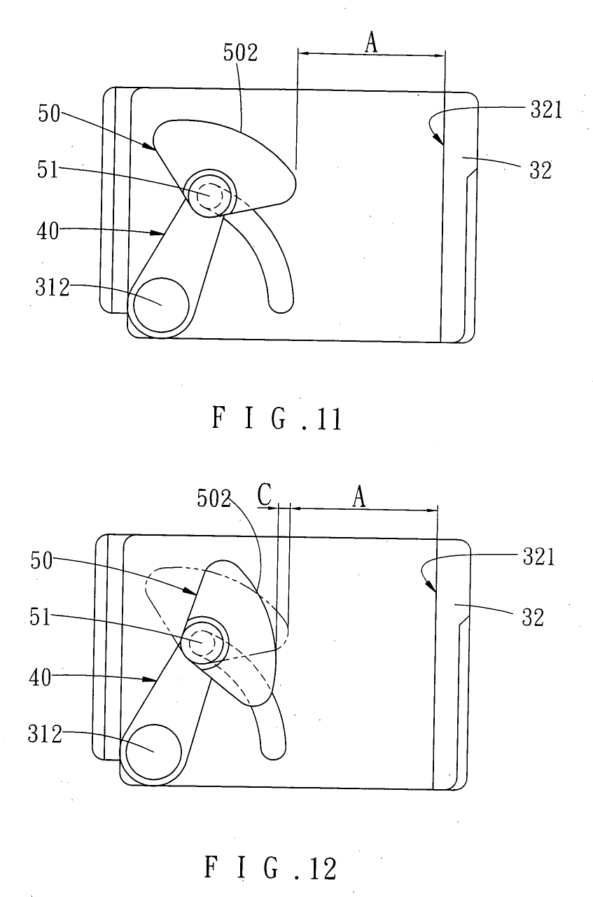

Referring to FIG. 11, if the clamping member 50 is not pivoted at the second pivotal axis 51, such as the clamping member 50 is integral with the rotatory piece 40, the clamping member 50 can only rotate around the first pivotal axis 312. In this situation, when the clamping member 50 rotates around the first pivotal axis 312 upward to the top position of a predetermined angle, the distance length A between the clamping surface 502 and the retaining wall 321 can be the maximum hanging range of hanging clamp for different size rods. In other words, if the diameter of a rod is more than the distance length A, the rod will not be clamped by the hanging clamp.

Referring to FIG. 12, if the clamping member 50 is pivoted at one end of rotatory piece 40 by using the second pivotal axis 51, when said rotatory piece 40 rotates around the first pivotal axis 312 upward to the top position of a predetermined angle, the distance length A between the clamping surface 502 and the retaining wall 321 will form, then the clamping member 50 can further rotates around the second pivotal axis 51 downward to a predetermined angle; accordingly, the distance length A+C between the clamping surface 502 and the retaining wall 321 will form, aforesaid additional distance length C will make the clamping surface 502 clamp a rod having a wider diameter, so as to expand the maximum hanging range of hanging clamp for different size rods. In other words, by using the changeable distance of double pivotal axis, the distance length between the clamping surface 502 and the retaining wall 321 can be further extended.

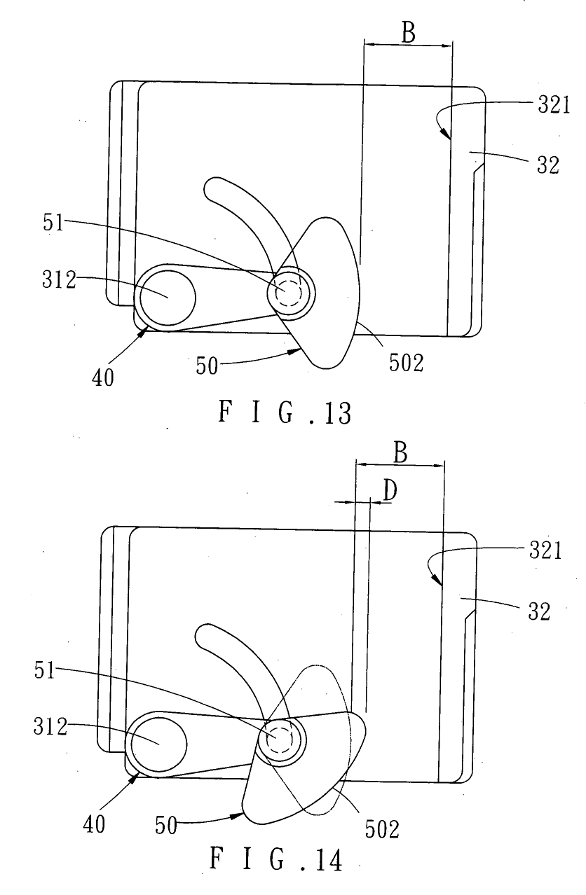

Referring to FIG. 13, if the clamping member 50 is not pivoted at the second pivotal axis 51, such as the clamping member 50 is integral with the rotatory piece 40, the clamping member 50 can only rotate around the first pivotal axis 312. In this situation, when the clamping member 50 rotates around the first pivotal axis 312 downward to the bottom position of a predetermined angle, the distance length B between the clamping surface 502 and the retaining wall 321 can be the minimum hanging range of hanging clamp for different size rods. In other words, if the diameter of a rod is less than the distance length B, the rod will not be clamped by the hanging clamp.

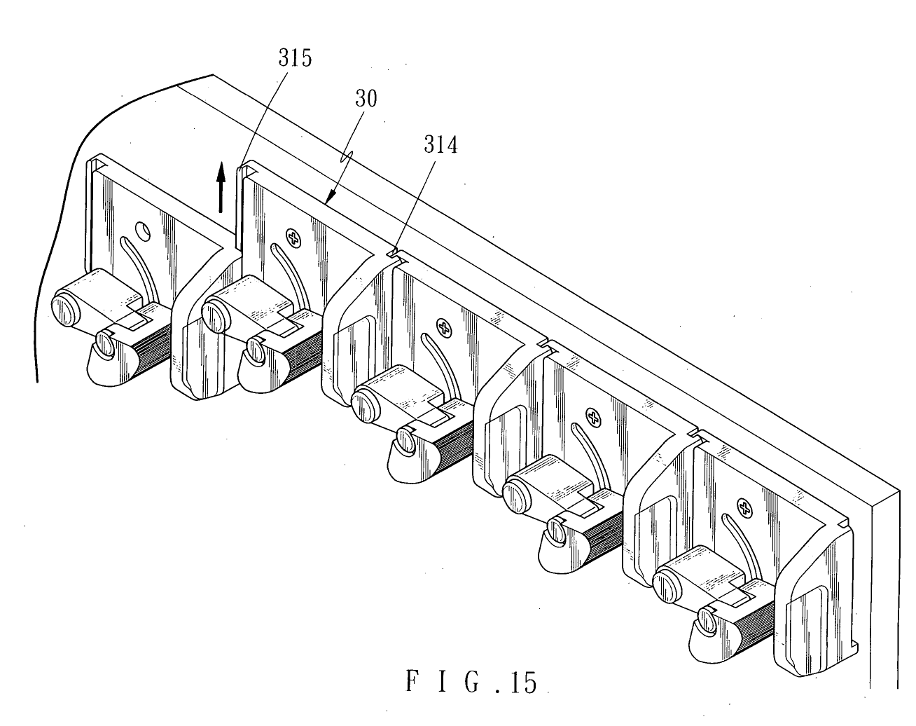

Referring to FIG. 14, if the clamping member 50 is pivoted at one end of rotatory piece 40 by using the second pivotal axis 51, when said rotatory piece 40 rotates around the first pivotal axis 312 downward to the bottom position of a predetermined angle, the distance length B between the clamping surface 502 and the retaining wall 321 will form, then the clamping member 50 can further rotates around the second pivotal axis 51 downward to a predetermined angle; accordingly, the distance length B-D between the clamping surface 502 and the retaining wall 321 will form, aforesaid reduced distance length D will make the clamping surface 502 clamp a rod having a smaller diameter, so as to improve the hanging range of hanging clamp for different size rods. In other words, by using the changeable distance of double pivotal axis, the distance length between the clamping surface 502 and the retaining wall 321 can be further shrunk.

Referring to FIG. 15, by using a plurality of retaining recesses 314 and a plurality of retaining projections 315, a plurality of hanging clamps for different size rods can be assemble together, and then said hanging clamp assembly for concurrently clamping a plurality of rods can be fixed to the wall. Hence, the manufacturing cost of the respective hanging clamps will be diminished.

While we have shown and described various embodiments in accordance with the present invention, it should be clear to those skilled in the art that further embodiments may be made without departing from the scope of the present invention.

What is claimed is:

1. A hanging clamp for different size rods comprising:
a L-shaped base having a body and an outwardly projected retaining portion, wherein the retaining portion is arranged at one end of body, a first pivotal axis is mounted at a proper position of body, at the retaining portion in response to the first pivotal axis is arranged a retaining wall;
a rotatory piece, of which one end for rotating around the first pivotal axis being pivoted at aforesaid first pivotal axis of body;
a clamping member, of which one end being pivotally coupled to the rotatory piece by using the second pivotal axis, at one side of clamping member in response to the retaining wall being formed an arc-shaped clamping surface.

2. The hanging clamp for different size rods as claimed in claim 1, wherein a plurality of through holes for fixing the body to the wall by using a plurality of bolts are respectively defined on the body.

3. The hanging clamp for different size rods as claimed in claim 1, wherein an arc-shaped slot having a predetermined angle is formed on the body by using the first pivotal axis as its center, at the bottom of clamping member in response to an arc-shaped slot is defined with a pivotal projection for being located and moving in the slot, whereby the rotation of rotatory piece around the first pivotal axis at a predetermined angle can be confined.

4. The hanging clamp for different size rods as claimed in claim 1, wherein a fitting slot is formed at one end of clamping member, by using the second pivotal axis, said fitting slot is coupled to another end of rotatory piece, when the clamping member rotates around the second pivotal axis, by using the walls of fitting slot respectively abutting against the top side and the bottom side of rotatory piece, the clamping member can rotate at a predetermined angle.

5. The hanging clamp for different size rods as claimed in claim 1, wherein an arc-shaped clamping surface of clamping member is an arc-shaped surface in form of a concentric circle.

6. The hanging clamp for different size rods as claimed in claim 1, wherein the center of circle of clamping surface is different from the center of first pivotal axis.

7. The hanging clamp for different size rods as claimed in claim 1, wherein an elastic pad having a plurality of soft and anti-slip strips thereon is affixed to the clamping surface, so as to enhance the clamping strength of clamping member.

8. The hanging clamp for different size rods as claimed in claim 1, wherein after the rotatory piece and the clamping member rotate upwardly, the clamping member can further rotate around the second pivotal axis downward to a predetermined angle, so as to extend the distance length between the clamping surface and the retaining wall in such a manner that the clamping range of hanging clamp for different size rods can be expanded.

9. The hanging clamp for different size rods as claimed in claim 1, wherein after the rotatory piece and the clamping member rotate downwardly, the clamping member can further rotate around the second pivotal axis downward to a predetermined angle, so as to shrink the distance length between the clamping surface and the retaining wall in such a manner that the clamping range of hanging clamp for different size rods can be expanded.

10. The hanging clamp for different size rods as claimed in claim 1, wherein at one end of body is provided with a retaining recess, while at another end of body is defined with a retaining projection, by using the retaining recesses and the retaining projections, a plurality of hanging clamps for different size rods can be assemble together and then said hanging clamp assembly for concurrently clamping a plurality of rods can be fixed to the wall.
